(19) United States
(12) Patent Application Publication
(10) Pub. No.: US 2012/0184118 A1
(43) Pub. Date: Jul. 19, 2012

(54) Network jack

(75) Inventors: Allen Lee, Taipei County (TW); Ryu Lee, Taipei County (TW)

(73) Assignee: Dan-Chief Enterprise Co.,Ltd., Taipei County (TW)

(21) Appl. No.: 13/199,914

(22) Filed: Sep. 13, 2011

(30) Foreign Application Priority Data
Jan. 14, 2011 (TW) 100101539

(51) Int. Cl. H01R 13/44

(52) U.S. Cl. 439/137

(57) ABSTRACT

A network jack is provided. The network jack includes a jack body having an opening and a side wall; a door body having a lateral protrusion; and a resilient pivot connecting the jack body and the door body and urging the lateral protrusion against the side wall.

### FIELD OF THE INVENTION

The present invention relates to a network jack, in particular to a network jack having a lateral protrusion on a door body for preventing the door body from being bounced out from the jack body.

### BACKGROUND OF THE INVENTION

Some of the network jacks are usually disposed with a door, for protecting the pins of the network jack and preventing from the invasion of foreign bodies. Please refer to FIG. 1, which is a diagram illustrating a biasable door which is originally quoted from U.S. Pat. No. 6,869,297 entitled “connector door having over travel stops”. The biasable door 10 includes a couple of forwardly directed projections 11 and a front plate 12. The front plate 12 has a flat surface. Please further refer to FIG. 2, which is a diagram illustrating a crystal plug resting in a conventional housing with door. After a crystal plug 20 is inserted into a housing 21 of a network jack, the forwardly directed projections 11 of the biasable door 10 as shown in FIG. 1 are utilized to secure the crystal plug 20 to the housing 21. However, such design can not actually resolve yet the vibrations between the connection of the crystal plug and the housing.

Please refer to FIG. 3, which is a diagram illustrating a conventional door configured with a torsional spring for a network jack. The door 30 configured with a torsional spring 31 disclosed in FIG. 3 has a first end 321 and a second end 322. When the door 32 is opened, the first end 321 is pivoted to reach a position parallel to the second end 322. For this moment, the torsion from spring 31 is raised, such that the first end 321 and the second end 322 may possibly interfere with each other to affect normal operations. Moreover, although the door 30 is disposed with a projection 33 having a length, the length is too short to cause the door easily bounced or pushed out from the housing as if the network jack is fallen or dropped. If it is straightforward to elongate the length of the projection 33, the projection 33 will collide the pins on the network jack. As to the frontage of the door 30, as shown in FIG. 4, it has different shape respectively on the left-half upper portion 41 and on the right-half upper portion 42. Thus the door 30 has an asymmetric design. Additionally, for the conventional network jack, while the door 30 is closed with the housing of the network jack, there exist gaps formed between the door and the housing despite observing from front or aerial view. Even though the crystal plug is inserted into the housing, there still exist quite large gaps between the door and the housing.

Therefore, it is important regarding how to improve the above-mentioned issues for a door element of network jack. After the inventor dedicates himself to experiment, test and study, he finally conceives an improved network jack which is design to effectively resolve the above-mentioned issues and at the same time, can also upgrade the stability for door element during an opening operation.

### SUMMARY OF THE INVENTION

The present invention provides a network jack with a door having a lateral protrusion can overcome the above-mentioned issues. The door of the network jack does not bounce out from the jack, even though the jack is fallen or dropped. Moreover, the door on the jack is more resistive to fall or drop and does not easily fall off from the housing. Furthermore, after the door is opened, two ends of spring do not interfere with each other and the opened door can maintain very good stability.

In accordance with the first aspect of the present invention, a network jack is provided. The network jack includes a jack body having an opening and a side wall; a door body having a lateral protrusion; and a resilient pivot connecting the jack body and the door body and urging the lateral protrusion against the side wall.

In accordance with the second aspect of the present invention, a plate element is provided. The plate element for closing an opening having a diagonal length of a network jack includes a door body having a height and configured to close the opening of the network jack; and a lateral protrusion extending from the door body and having a length, wherein a sum of the height and the length is larger than the diagonal length.

In accordance with the third aspect of the present invention, a plate element is provided. The plate element for closing an opening having a first characteristic length of a network jack includes a door body having a second characteristic length and configured to close the opening of the network jack; and a lateral protrusion extended from the door body and having a third characteristic length, wherein a sum of the second and. the third characteristic lengths is larger than the first characteristic length.

In accordance with the fourth aspect of the present invention, a network jack is provided. The network jack includes a lower wall and a spring pivotally configured between the lower wall and the plate element and having an end, including a slot configured to contain the end when the plate element contacts the lower wall.

In accordance with the fifth aspect of the present invention, a network jack is provided. The network jack includes a jack body having a lower wall; a door body having a recess and pivotally connected with the jack body; and a spring having an end and configured between the jack and the door bodies, wherein the end is contained in the recess while the door body contacts the lower wall.

Other objects, advantages and efficacy of the present invention will be described in detail below taken from the preferred embodiments with reference to the accompanying drawings, in which:

### BRIEF DESCRIPTION OF THE DRAWINGS

FIG. 1 is a diagram illustrating a biasable door which is originally quoted from U.S. Pat. No. 6,869,297 entitled “connector door having overtravel stops”;

FIG. 2 is a diagram illustrating a crystal plug resting in a conventional housing with door;

FIG. 3 is a diagram illustrating an another conventional door configured with a torsional spring for a network jack;

FIG. 4 is a diagram illustrating a frontage of the door shown in FIG. 3;

FIG. 5 is a schematic diagram illustrating the preferred embodiment according to the present invention;

FIG. 6 is a diagram illustrating a backside of a door body as shown in FIG. 5 which is assembled with the spring;

FIG. 7 is a diagram illustrating the assembly of the first stabilizer and the second stabilizer after the door is opened;

FIG. 8 is a diagram illustrating the insertion of the crystal plug into the jack;

FIG. 9 is a diagram illustrating the urge of the lateral protrusion of the door as shown in FIG. 5 against the inner wall of the jack;

FIG. 10 is a diagram illustrating the slot of the door body;

FIG. 11 is a diagram illustrating an aerial view for the door as shown in FIG. 5 which has been assembled with the jack but not opened yet;

FIG. 12 is a diagram illustrating an aerial view for the assembly of the door as shown in FIG. 5 and the jack into which a crystal plug is placed; and

FIG. 13 is a diagram illustrating the assembly of the door as shown in FIG. 5 and the jack where the door is revolved to be in an open state.

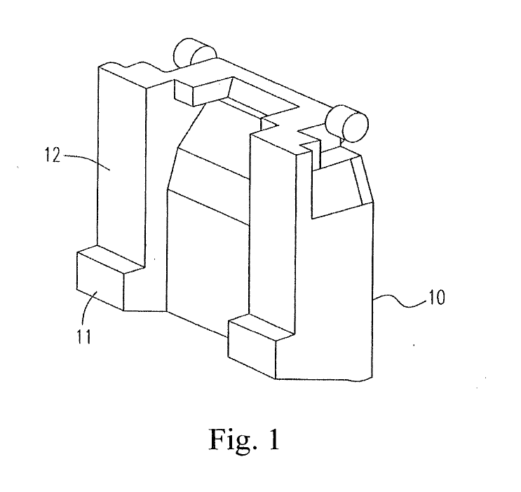

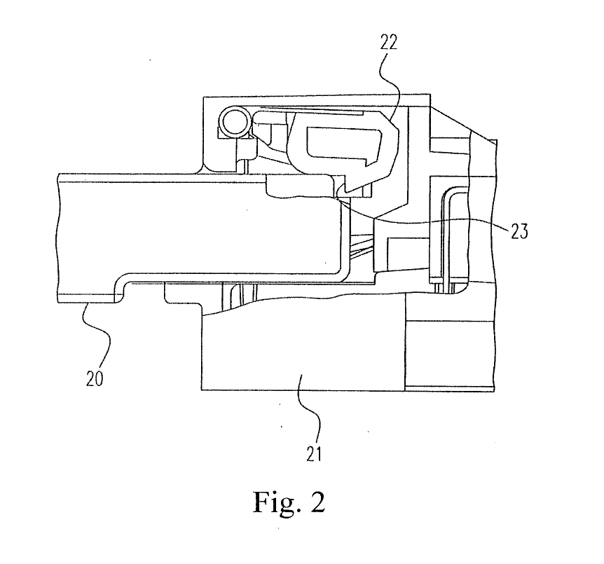

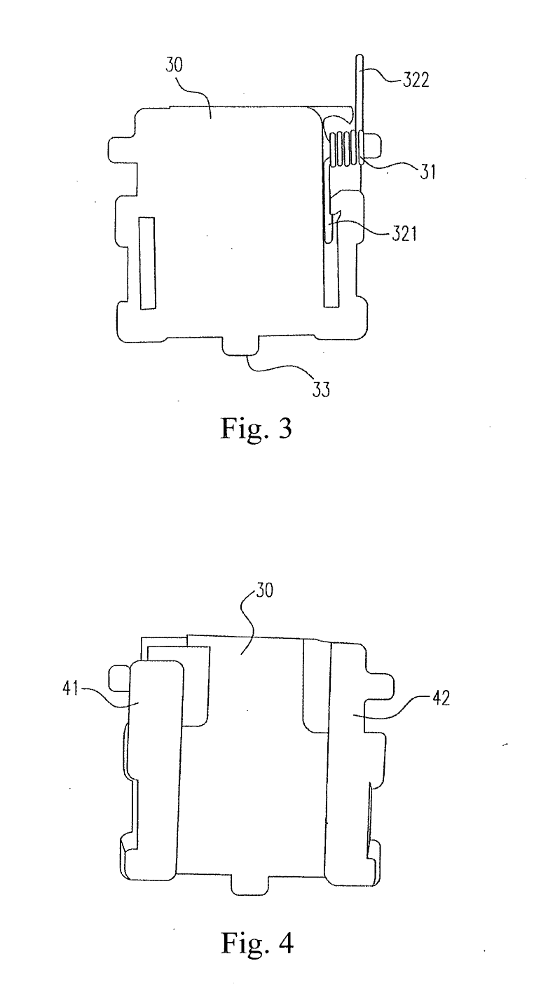

### DETAILED DESCRIPTION OF THE PREFERRED EMBODIMENT

The present invention will now be described more specifically with reference to the following embodiments. It is to be noted that the following descriptions of preferred embodiments of this invention are presented herein for purposes of illustration and description only; it is not intended to be exhaustive or to be limited to the precise form disclosed.

While the present invention is exemplarily described by reference to the preferred embodiments and examples regarding the mutual connection of a plurality of bonding pads of a display and a plurality of bonding pads of an external circuit for performing signal exchange and communication, it is to be understood that these examples are intended in an illustrative rather than in a limiting sense. It is contemplated that modifications and combinations will readily occur to those skilled in the art, which modifications and combinations will be within the spirit of the invention.

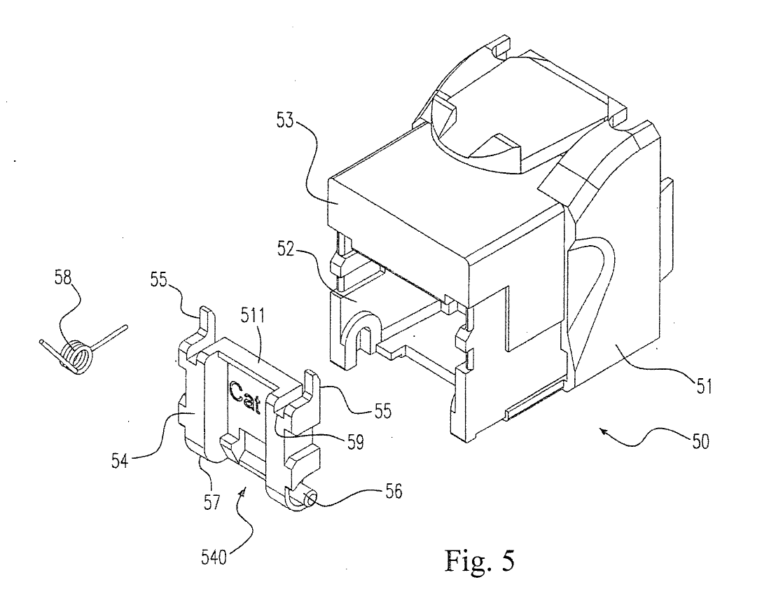

Please refer to FIG. 5, which is a diagram illustrating the preferred embodiment according to the present invention. The network jack 50 disclosed in FIG. 5 includes a jack body 51 having an opening 52, a side wall 53, a door body 54 having two lateral protrusions 55 and a pivot 56 connected between the jack body 51 and the door body 54 for urging the lateral protrusions 55 against the side wall 53. The door body 54 further has a spring shelter 57 for protecting the spring 58. The network jack 50 further includes two first stabilizers 59 disposed on the door body 54 for stabilizing the door body 54 during being opened. The respective first stabilizers 59 are a groove.

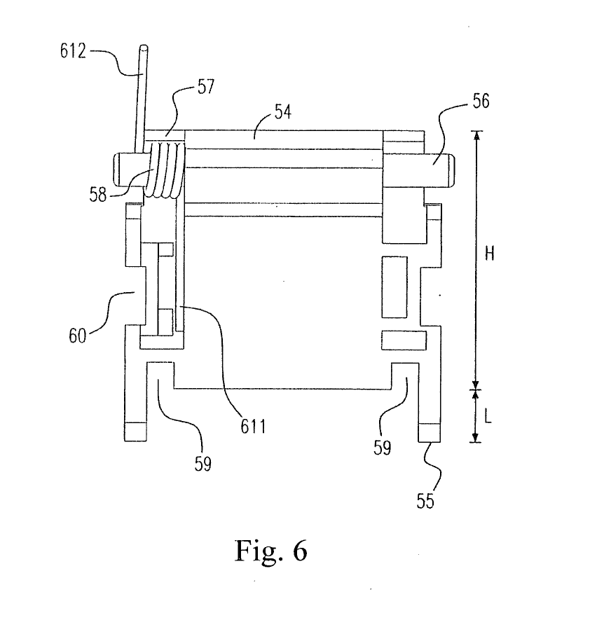

Please refer to FIG. 6, which illustrates a backside of a door body as shown in FIG. 5 which is assembled with the spring. The respective lateral protrusions 55 are a projected tenon which is design to be utilized for preventing the door body 54 from being bounced out from the jack body 51. The door body 54 further has two recesses 60 symmetrically situated in left and right sides of the door body 54. The pivot 56 is configured with the spring 58. The spring 58 has a first end 611 and a second end 612 which is contained in one of the recesses 60. The recesses 60 are utilized for preventing the first end 611 and the second end 612 from being interfered with each other, since the second end 612 is operated to be contained in one of the recesses 60.

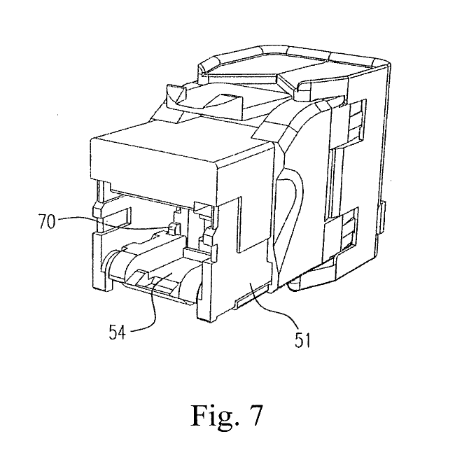

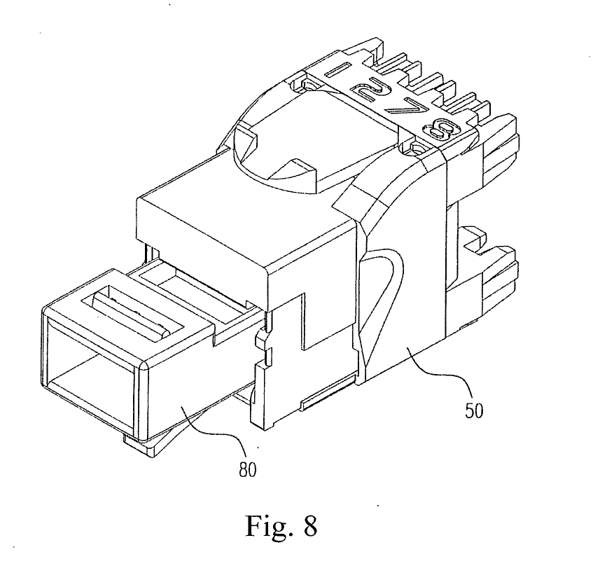

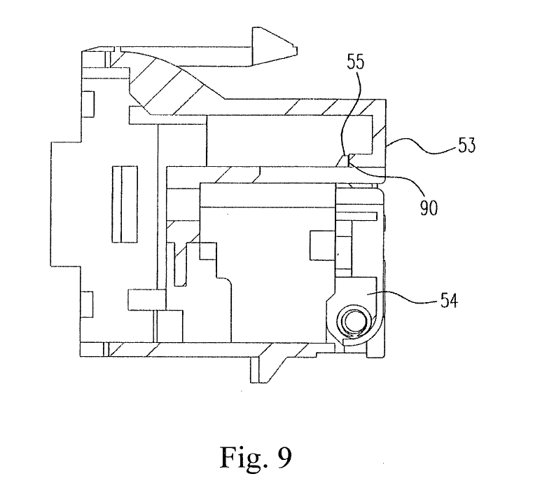

Please refer to FIG. 7, which illustrates the assembly of the first stabilizer and the second stabilizer after the door is opened. The two first groove stabilizers 62 are respectively operated to be correspondingly embedded into two tenons 70 (only one tenon capable to be shown in FIG. 7) acting as a second stabilizer on the jack body 51. As shown in FIG. 8, when the crystal plug 80 is inserted into the network jack 50, the door body 54 can be stably fixed to the jack body 51 through the application of the stabilizer 62. Please further refer to FIG. 9, which illustrates the urge of the lateral protrusion of the door shown in FIG. 5 against the inner wall of the jack. The jack body 51 further has an inner wall 90 extended from the sidewall 53 and the lateral protrusions 55 urges against the inner wall 90.

Alternatively, in another point of view, the present invention provides a network jack 50 having a door 540 for closing an opening 52 of the network jack 50. The opening 52 has a diagonal length. The door 540 includes the door body 54 having a height H and a protrusion 55 (e.g.: the lateral protrusion) extending from the door body 54 and having a length L, wherein the sum of the height H and the length L is larger than the diagonal length. Certainly, the door 540 can further configure with a spring 58. If the protrusion 55 is a flexible plate, it can be disposed at a central position 511 as shown in FIG. 5.

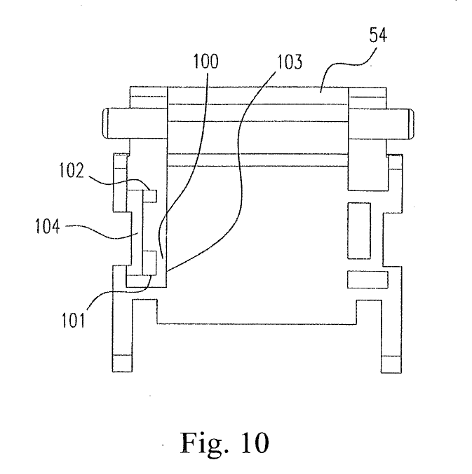

Please refer to FIG. 10, which illustrates the slot of the door body. The door 540 includes a slot 100 for containing a first end 611 of the spring 58. The slot 100 is formed by a first projection 101 and a second projection 102 and the right lateral wall 103. The door body 54 has a left lateral wall 104.

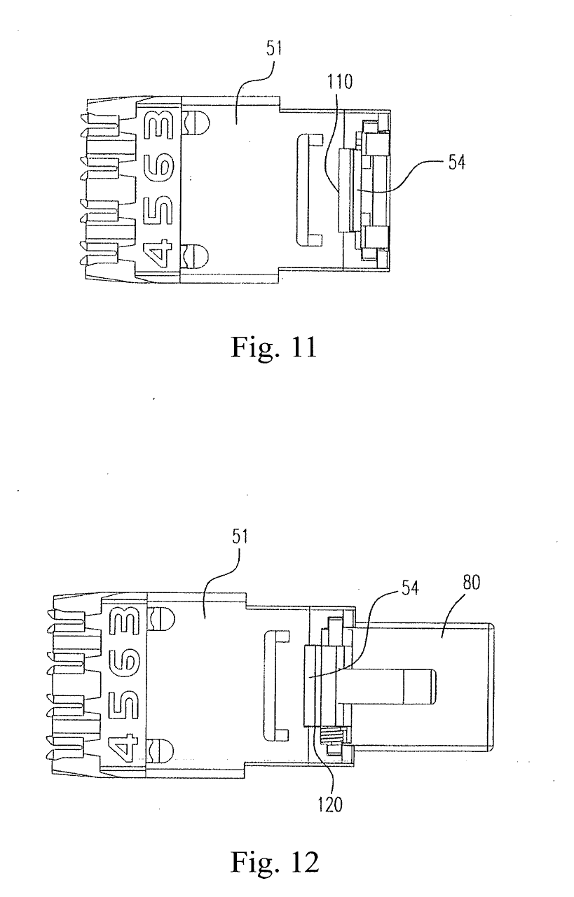

Please refer to FIG. 11, which discloses that the gap 110 existing between the unopened door 540 and the jack body 51 is much tight. Further refer to FIG. 12, which discloses that when the door 540 is opened by the crystal plug 80, the gap 120 existing between the door 540 and the jack body 51 is also much tight.

Alternatively, in another point of view, the present invention provides a network jack 50 having a door 540 for closing an opening 52 of the network jack 50. The opening 52 has a first characteristic length. The door 540 includes the door body 54 having a second characteristic length and a protrusion 55 (e.g.: the lateral protrusion) extending from the door body 54 and having a third characteristic length, wherein the sum of the second characteristic length and third characteristic length is larger than the first characteristic length. Certainly, the protrusion 55 is preferably extended from one being selected from a group consisting of places in a width direction, a height direction and a corner direction of the door body 54 and the first characteristic length is preferably one of a transverse width and a diagonal length of the opening 52, the second characteristic length is a height H of the door body 54 and the third characteristic length is an extension length L of the lateral protrusion 55.

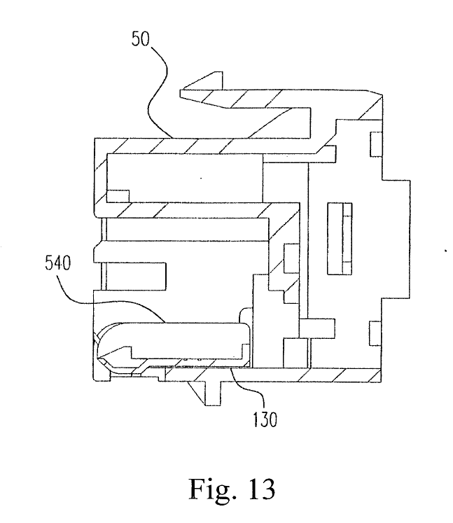

Alternatively, in another point of view, the present invention provides a door element 540 for closing the network jack 50. The network jack 50 includes a spring 58 pivotally disposed between the network jack 50 and the door element 540, wherein the spring 58 has a first end 611 and a second end 612. The door element 540 includes a slot 100 for containing the first end 611 and a recess 60 for containing the second end 612, while the door element 540 is opened to urge against a lower wall 130 of the network jack 50 as shown in FIG. 13.

Alternatively, in another point of view, the present invention provides a network jack 50 including a jack body 51, a door body 54 and a resilient pivot 56 which is connected between the jack body 51 and the door body 54 and configured with a spring 58. The spring 58 has a first end 611 and a second end 612. The network jack 50 is characterized in that the door body 54 further includes a slot 100 for containing the first end 611 and a recess 612 for containing the second end 612, while the door body 54 is opened to urge against a lower wall 130 of the jack body 51. The recess is preferably a cut-out space.

There are more preferable embodiments provided as follows:

Embodiment 1: a network jack includes a jack body having an opening and a side wall; a door body having a lateral protrusion; and a resilient pivot connecting the jack body and the door body and urging the lateral protrusion against the side wall.

Embodiment 2: the network jack. according to embodiment 1, the door body has an edge, the side wall has an inner wall contacting the lateral protrusion, the lateral protrusion is a pillar protruding from the edge, the resilient pivot is disposed on the door body and includes a spring with a first end and a second end, the door body has a spring shelter protecting the spring and has a slot and a recess, and the first and the second ends are respectively contained in the slot and the recess to prevent from being interfered with each other.

Embodiment 3: the network jack according to embodiment 1, the door body has a first stabilizer being a groove, the jack body has a second stabilizer being a tenon and the first stabilizer is operated to be correspondingly embedded into the second stabilizer for securing the door body to the jack body.

Embodiment 4: a plate element for closing an opening having a diagonal length of a network jack includes a door body having a height and configured to close the opening of the network jack; and a lateral protrusion extending from the door body and having a length, wherein a sum of the height and the length is larger than the diagonal length.

Embodiment 5: the plate element according to embodiment 4 further includes a spring having a first end and a second end and configured on the door body.

Embodiment 6: the plate element according to embodiment 4, the lateral protrusion is a flexible plate, the door body has a slot and a recess, and the first and the second ends are respectively contained in the slot and the recess.

Embodiment 7: a plate element for closing an opening having a first characteristic length of a network jack includes a door body having a second characteristic length and configured to close the opening of the network jack; and a lateral protrusion extended from the door body and having a third characteristic length, wherein a sum of the second and the third characteristic lengths is larger than the first characteristic length.

Embodiment 8: the plate element according to embodiment 7, the first characteristic length is one of a width and a diagonal length of the opening, the second characteristic length is a height of the door body and the third characteristic length is an extension length of the lateral protrusion.

Embodiment 9: the plate element according to embodiment 7, the lateral protrusion is extended from one being selected from a group consisting of places in a width direction, a height direction and a corner direction of the door body.

Embodiment 10: a plate element for closing a network jack, the network jack includes a lower wall and a spring pivotally configured between the lower wall and the plate element and having an end, including a slot configured to contain the end when the plate element contacts the lower wall.

Embodiment 11: a network jack includes a jack body having a lower wall; a door body having a recess and pivotally connected with the jack body; and a spring having an end and configured between the jack and the door bodies, wherein the end is contained in the recess while the door body contacts the lower wall.

Embodiment 12: the network jack according to embodiment 11, the recess is a cut-out space.

In brief, the present provides a network jack including a jack body and a door. The door is disposed with a lateral protrusion capable of containing one of the first and the second ends of the spring configured between the door for the preventing the mutual interference of the first and second ends of the spring and moreover, the lateral protrusion can also prevent the door bounced out from the network jack.

While the invention has been described in terms of what is presently considered to be the most practical and preferred embodiments, it is to be understood that the invention needs not be limited to the disclosed embodiments. Therefore, it is intended to cover various modifications and similar configuration included within the spirit and scope of the appended claims, which are to be accorded with the broadest interpretation so as to encompass all such modifications and similar structures.

What is claimed is:

1. A network jack, comprising:
a jack body having an opening and a side wall;
a door body having a lateral protrusion; and
a resilient pivot connecting the jack body and the door body and urging the lateral protrusion against the side wall.

2. The network jack according to claim 1, wherein the door body has an edge, the side wall has an inner wall contacting the lateral protrusion, the lateral protrusion is a pillar protruding from the edge, the resilient pivot is disposed on the door body and comprises a spring with a first end and a second end, the door body has a spring shelter protecting the spring and has a slot and a recess, and the first and the second ends are respectively contained in the slot and the recess to prevent from being interfered with each other.

3. The network jack according to claim 1, wherein the door body has a first stabilizer being a groove, the jack body has a second stabilizer being a tenon and the first stabilizer is operated to be correspondingly embedded into the second stabilizer for securing the door body to the jack body.

4. A plate element for closing an opening having a diagonal length of a network jack, comprising:
a door body having a height and configured to close the opening of the network jack; and
a lateral protrusion extending from the door body and having a length, wherein a sum of the height and the length is larger than the diagonal length.

5. The plate element according to claim 4 further comprising a spring having a first end and a second end and configured on the door body.

6. The plate element according to claim 4, wherein the lateral protrusion is a flexible plate, the door body has a slot and a recess, and the first and the second ends are respectively contained in the slot and the recess.

7. A plate element for closing an opening having a first characteristic length of a network jack, comprising:
a door body having a second characteristic length and configured to close the opening of the network jack; and
a lateral protrusion extended from the door body and having a third characteristic length, wherein a sum of the second and the third characteristic lengths is larger than the first characteristic length.

8. The plate element according to claim 7, wherein the first characteristic length is one of a width and a diagonal length of the opening, the second characteristic length is a height of the door body and the third characteristic length is an extension length of the lateral protrusion.

9. The plate element according to claim 7, wherein the lateral protrusion is extended from one being selected from a group consisting of places in a width direction, a height direction and a corner direction of the door body.

10. A plate element for closing a network jack, wherein the network jack comprises a lower wall and a spring pivotally configured between the lower wall and the plate element and having an end, comprising a slot configured to contain the end when the plate element contacts the lower wall.

11. A network jack, comprising:
a jack body having a lower wall;
a door body having a recess and pivotally connected with the jack body; and
a spring having an end and configured between the jack and the door bodies, wherein the end is contained in the recess while the door body contacts the lower wall.

12. The network jack according to claim 11, wherein the recess is a cut-out space.
